(19) United States
(12) Patent Application Publication
(10) Pub. No.: US 2003/0097412 A1
(43) Pub. Date: May 22, 2003

(54) Method and apparatus for forwarding electronic mail for disabled accounts

(76) Inventor: Kingsum Chow, Hillsboro, OR (US)

Correspondence Address: Pillsbury Winthrop LLP, Intellectual Property Group, Suite 2800, 725 So. Figueroa Street, Los Angeles, CA, 90017-5406, US

(21) Appl. No.: 09/990,256

(22) Filed: Nov. 20, 2001

(51) Int. Cl. G06F 15/16

(52) U.S. Cl. 709/206; 709/238

(57) ABSTRACT

A system for forwarding electronic mail from disabled accounts is disclosed. Users wishing to forward their electronic mail from one account to another register themselves on the system. Other users, who wish to send electronic mail to individuals in need of forwarding, send electronic mail to the system using the former electronic mail address of the recipients. The system's server forwards the electronic mail if a new forwarding address is found, or forwards to the former electronic mail address if no new address is found. For resolved electronic mail that is forwarded by the system, the sender's electronic mail address is transferred to the recipient who has the option of responding to the sender directly or through the system. The recipient's current electronic mail address may be made unavailable to the sender. For unresolved electronic mail addresses, the sender receives a message describing the error encountered while attempting delivery.

### BACKGROUND

1. Field of the Invention

Embodiments described herein are directed to a system for forwarding electronic mail for disabled accounts. Specifically, users who want their electronic mail forwarded from one account to another register themselves on the system. Users who want to send electronic mail to individuals in need of forwarding send the electronic mail to the system using the former addresses of the recipients. The system then forwards the electronic mail if a new forwarding address is found or simply forwards to the former electronic mail address if a new address is not found. In addition, a user who sends an undeliverable electronic mail to a recipient may then resend it to the system for forwarding.

2. Related Art

Most current systems allow forwarding options for active accounts. Some organizations, such as acm.org, for example, provide electronic mail forwarding as long as an individual remains a member of the organization. Yet, no systems are employed for forwarding electronic mail for a disabled account when the individual does not remain as a member of a specific company or organization. For instance, to encourage users not to change providers, Internet Service Providers (“ISP”) do not forward electronic mail for a user once that user switches providers. As such, many users who are dissatisfied with an ISP continue to use the provider so as not to worry about losing valuable electronic mail messages.

Anonymous re-mailers rely on a third server to forward electronic mail. With anonymous re-mailers, the sender's identity is hidden while the recipient's identity is known. There exists, however, a legitimate business need for a different approach in which the sender's identity is known while the electronic mail address of the recipient is unknown. In this way, the probability of misuse of the system is reduced, and privacy of the recipient is maintained.

There is, therefore, a need for an inexpensive and universal solution to enable a user to change service providers or to continue to receive electronic mail after leaving a company.

### BRIEF DESCRIPTION OF THE DRAWINGS

A detailed description of embodiments of the invention will be made with reference to the accompanying drawings, wherein like numerals designate corresponding parts in the several figures.

FIG. 1 is an illustration of the components of an apparatus for forwarding electronic mail for disabled accounts, according to an embodiment of the present invention.

FIG. 2 is a flowchart showing the steps involved in forwarding electronic mail for disabled accounts, according to an embodiment of the present invention.

### DETAILED DESCRIPTION

The following paragraphs describe a method and apparatus for forwarding electronic mail for disabled accounts. Oftentimes, electronic mail sent to a former electronic mail address cannot be forwarded to a new electronic mail address for a variety of reasons. For example, an AOL customer may wish to subscribe to another service provider such as NetZero or Earthlink. AOL does not provide electronic mail forwarding services, however, so as to discourage subscribers from leaving its service. As another example, an individual working for a company may change jobs. The company, for security reasons, does not forward electronic mail. In both cases, there is a need for the individual who migrates to a new electronic mail address to notify others of the change. Of course, not all interested parties may be notified because of careless omissions. In addition, not all interested parties may update their address books promptly to reflect the change in the electronic mail address.

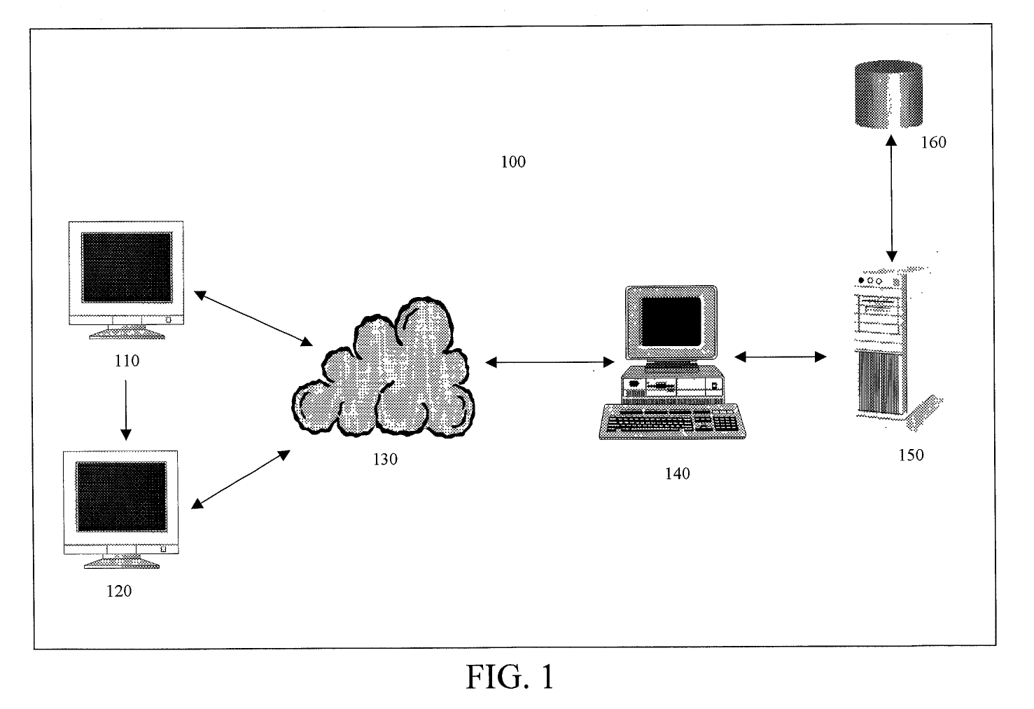

According to one embodiment of the present invention, as illustrated in FIG. 1, an electronic mail forwarding system for disabled accounts 100 is comprised of a server 150 that performs forwarding searches and forwarding actions. A database 160 is included for entering, updating, and maintaining both source and destination electronic mail addresses for forwarding.

User-computers 110 who want their electronic mail forwarded from one account to another account register themselves on the electronic mail forwarding system for disabled accounts 100. That is, the user-computers 110 send a message to the forwarding system's account 140, e.g. portal@mf.com, where mf.com is the company that provides the forwarding service, over a data communication network 130. The data communication network 130 may be the Internet, an intranet, or any other kind of public, private, or other data communication network. The forwarding system's account 140 may be located on the server 150 or may be a separate, intermediary computer.

Sender-computers 120, who wish to send electronic mail to user-computers 110 in need of forwarding or who have unsuccessfully attempted delivery to a user-computer's 110 electronic mail address which is no longer reachable, send electronic mail to the forwarding system's account 140 over the data communication network 130 using the last known electronic mail addresses of the user-computers 110. The sender-computers 120 do not need to know which electronic mail addresses need forwarding. Instead, the sender-computers 120 simply address the electronic mail as usual.

The server 150 of the electronic mail forwarding system for disabled accounts 100 then forwards the electronic mail provided that a new forwarding address is found. If a new address is not located, then the server 150 simply forwards the electronic mail to the last known electronic mail address. For a resolved electronic mail that is forwarded successfully by the forwarding system 100, the sender-computer's 120 electronic mail address is transferred to the user-computer 110. User-computer 110 then has the option of either responding to the sender-computer 120 directly or responding through the forwarding system's account 140. In the latter case, the user-computer's 110 most current electronic mail address may be made unavailable to the sender-computer 120, for privacy concerns. In another embodiment of the present invention, the sender-computer 120 may receive a message from the forwarding system's account 140 stating that the sender-computer's 120 electronic mail was forwarded successfully to user-computer 110 and that user-computer 110 will respond at his convenience. In another variation of this scenario, the user-computer 110 may compose a message indicating that user-computer 110 has received a forwarded message. User-computer 110 may choose to provide sender-computer 120 with user-computer's 110 new electronic mail address.

For unresolved electronic mail addresses, the sender-computer 120 will receive the typical messages that describe undeliverable mails, if indeed the electronic mail account is not reachable for some reason. The message will further indicate that no forwarding account information is available.

Data clean-up for the database 160 is performed by a suitable software program that is equipped to detect forwarding cycles such as A to B and B to A and remove them as well as to detect chaining and simplify them. For instance, an electronic mail from A to B that is then forwarded from B to C may be simplified as transmitted from A to C. Another software program is implemented to add fields to the forwarded electronic mail, including a sender-computer's 120 electronic mail address as well as the address to which the electronic mail was initially targeted. An address bank for each user-computer 110 is also included which includes the user-computer's 110 disabled and new electronic mail address. A software program that can delay the forwarding of electronic mail, if necessary or at a specified time may further be used.

Plugins for sender-computers 120 who use the electronic mail forwarding system for disabled accounts 100 are also included. The sender-computers 120 may optionally use these plugins for convenience. The plugins transform user-computers' 110 electronic mail addresses and adds them as part of the electronic mail body. The plugins further inform sender-computers 120 that the electronic mail has been transformed and not directed to the user-computers' 110 electronic mail address directly.

For instance, the following provides an example of an electronic mail that may be composed by sender-computer 120 using Simple Mail Transfer Protocol (“SMTP”), RFC821, published August 1982, authored by Jonathan B. Postel, syntax (“S” is the sender-computer and “U” is the user-computer):

S: MAIL FROM: sender@hightech.com

U: 250 OK

S: RCPT TO: user@expensiveISP.com

U: 250 OK

S: DATA

U: 354 Start mail input; end with <CRLF>. <CRLF>

S: Hello, how are you? . . .

U: 250 OK

S: QUIT

The following is an example of how the original electronic mail message composed by sender-computer 120 may be modified manually or transformed automatically by a mail plugin program. This is the electronic mail that is sent to the forwarding system's account 140.

S: MAIL FROM: sender@hightech.com

U: 250 OK

S: RCPT TO: portal@mf.com

U: 250 OK

S: MFWD: user@expensiveISP.com

U: 354 Start mail input, end with <CRLF>. <CRLF>.

S: Hello, how are you? . . .

U: 250 OK

S: QUIT

The following example now shows the electronic mail message as forwarded to user-computer 110 after the server 150 determined to which address to forward. The user-computer 110 is provided with the identity of the sender-computer 120 and from which electronic mail account the message is being forwarded.

S: MAIL FROM: sender@hightech.com

U: 250 OK

S: RCPT TO: user@cheapISP.com

U: 250 OK

S: DATA

S: MFTO: user@expensiveISP.com

U: 354 Start mail input; end with <CRLF>. <CRLF>

S: Hello, how are you? . . .

U: 250 OK

S: QUIT

The examples above illustrate how software programs may be constructed to implement the method. Although only simple examples of forwarding to one electronic mail address are provided, the server 150 of the electronic mail forwarding system for disabled accounts 100 can perform multiple forwarding operations by using repeated mail forward “MFWD” strings, for example.

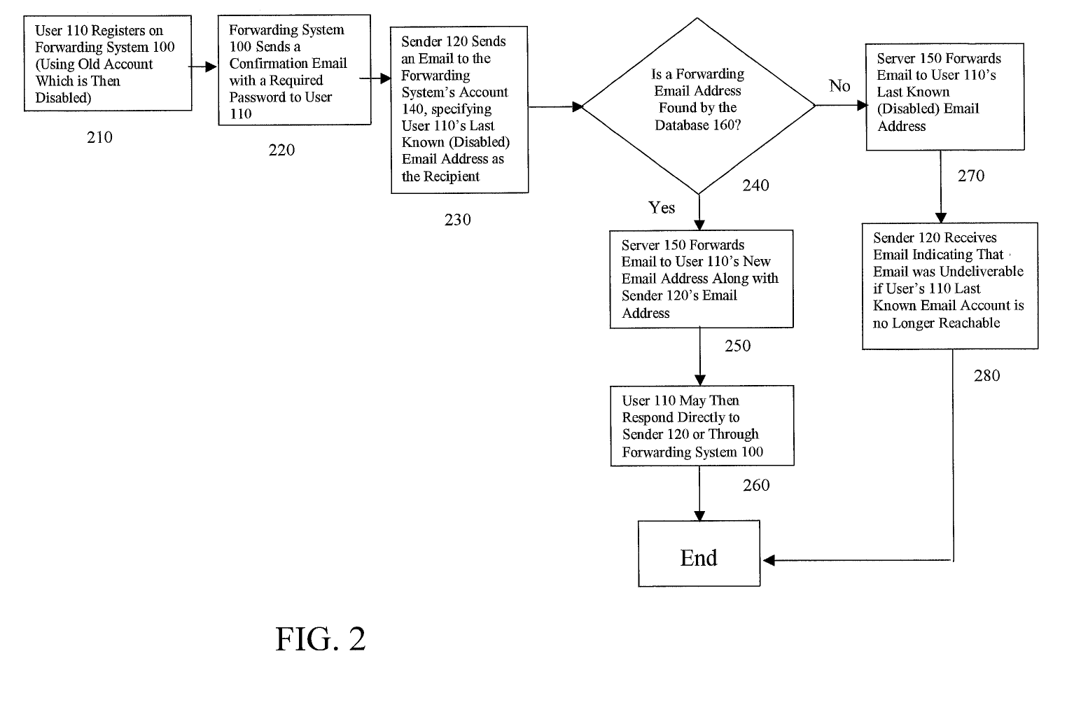

According to an embodiment of the present invention, FIG. 2 illustrates how the system operates. A user-computer 110 wishes to leave her existing Internet Service Provider “expensiveISP.com” to another provider “cheapISP.com.” The user-computer's 110 old and new electronic mail accounts are user@expensiveISP.com and user@cheapISP.com, respectively. As shown in step 210, before user-computer 110 leaves expensiveISP.com entirely, user-computer 110 registers on the electronic mail forwarding system for disabled accounts 100, e.g., mf.com to have electronic mails forwarded from user@expensiveISP.com to user@cheapISP.com. The old account is then disabled after registration. As depicted in step 220, mf.com verifies with the user-computer 110 that the user-computer 110 is legitimate by sending an electronic mail with a required password to user@expensiveISP.com.

A sender-computer 120, e.g. sender@hightech.com, wishes to send electronic mail to user-computer 110. Sender-computer 120 vaguely remembers that user-computer 110 planned on changing electronic mail accounts. Yet, sender-computer 120 does not have the updated information. As described by step 230, sender-computer 120 uses the electronic mail forwarding system for disabled accounts 100 by sending an electronic mail to the forwarding system's account 140, e.g. portal@mf.com. Sender-computer 120 specifies user@expensiveISP.com as the intended recipient. The electronic mail forwarding system for disabled accounts 100 then searches its database 160 for a forwarding electronic mail address. This action is shown in step 240. As described in step 250, if the database 160 locates a match, the server 150 then forwards the electronic mail to user@cheapISP.com along with information about the original sender-computer 120. As such, the user-computer 110 may then respond directly to the sender-computer 120 or may respond to the sender-computer 120 indirectly through the electronic mail forwarding system 100, as illustrated in step 260. Moreover, the sender-computer 120 may receive a message, composed by either the system or the user-computer 110, stating that the electronic mail has been forwarded. The user-computer 110 may wish to provide the new electronic mail address to sender-computer 120.

When the database 160 does not find a new destination electronic mail address, the server 150 simply forwards the electronic mail to the user-computer's 110 former electronic mail address. This action is described in step 270. As depicted in step 280, the sender-computer 120 then receives a message from the electronic mail forwarding system for disabled accounts 100 indicating that the electronic mail was undeliverable as the user-computer's 110 old account is no longer reachable and that no forwarding account information is available.

While the above description refers to particular embodiments of the present invention, it will be understood to those of ordinary skill in the art that modifications may be made without departing from the spirit thereof. The accompanying claims are intended to cover any such modifications as would fall within the true scope and spirit of the present invention.

The presently disclosed embodiments are therefore to be considered in all respects as illustrative and not restrictive; the scope of the invention being indicated by the appended claims, rather than the foregoing description. All changes that come within the meaning and range of equivalency of the claims are therefore intended to be embraced therein.

What is claimed is:

1. A system to forward electronic mails for disabled accounts in a data communication network, comprising:
a server, within the data communication network, to receive data from a database, to host forwarding searches, and to perform forwarding actions; and
a database, in communication with the server within the data communication network, that enters, updates, and maintains source and destination electronic mail addresses for forwarding; wherein the system is adapted to:
receive a registration of an electronic mail account of a user to forward to a new electronic mail address;
send a confirmation electronic mail with a required password to the user;
receive an electronic mail message from a sender that specifies the user's electronic mail account as a recipient;
search for the new electronic mail address for the user for forwarding; and
forward the electronic mail message to the new electronic mail address.

2. The system of claim 1, wherein the data communication network includes at least one of the Internet and an Intranet.

3. The system of claim 1, wherein the user's electronic mail account is disabled after the registration.

4. The system of claim 1, wherein the server forwards an electronic mail address of the sender to the user.

5. The system of claim 4, wherein the user responds to one of the sender directly and to the sender indirectly through the server.

6. The system of claim 1, wherein the user's new electronic mail address is made unavailable to the sender.

7. The system of claim 1, wherein the electronic mail message from the sender is forwarded to the user's electronic mail account, if the new electronic mail address is not found.

8. The system of claim 7, wherein the sender receives an electronic mail message indicating that the sender's electronic mail message is undeliverable if the user's electronic mail account is no longer reachable.

9. The system of claim 1, wherein the sender receives an electronic mail message from the user informing the sender that the sender's electronic mail message was forwarded.

10. An electronic mail forwarding system for disabled accounts comprising a computer readable medium and a computer readable program code stored on the computer readable medium having instructions to:
receive a registration of an electronic mail account of a user to forward to a new electronic mail address;
send a confirmation electronic mail with a required password to the user;
receive an electronic mail message from a sender that indicates the user's electronic mail account as a recipient;
search a database for the new electronic mail address of the user for forwarding;
forward the electronic mail message to the new electronic mail address;
make available an electronic mail address of the sender to the user;
dispatch the electronic mail message to the user's electronic mail account, if the new electronic mail address is not found; and
send an electronic mail message to the sender indicating that the sender's electronic mail message to user is undeliverable.

11. The system of claim 10, wherein the instructions are provided to a server to host forwarding searches and to execute forwarding actions.

12. The system of claim 10, wherein the instructions are provided to a database to input, monitor, and update an electronic mail address for forwarding.

13. The system of claim 12, wherein the user's electronic mail account is disabled after the database receives instructions to input the electronic mail account.

14. The system of claim 10, wherein the user has an option of responding directly to the sender's electronic mail address.

15. The system of claim 11, wherein the user has an option of responding indirectly to the sender through the server.

16. The system of claim 10, wherein the sender is informed that the electronic mail message of the sender has been delivered to the new electronic mail address of the user.

17. A method of forwarding electronic mails for a disabled account over a data communication network, comprising:
receiving a registration of an electronic mail account of a user to forward to a new electronic mail address;
receiving an electronic mail message from a sender that specifies the user's electronic mail account as a recipient;
searching for the new electronic mail address of the user for forwarding;
forwarding the electronic mail message to the new electronic mail address;
providing an electronic mail address of the sender to the user;
forwarding the electronic mail message to the user's electronic mail account, if the new electronic mail address is not found; and
sending an electronic mail message to the sender indicating that the sender's electronic mail message to user is undeliverable.

18. The method of claim 17, wherein the data communication network includes at least one of the Internet and an Intranet.

19. The method of claim 17, wherein a server, having circuitry to receive data from a database, performs forwarding searches and provides forwarding actions.

20. The method of claim 19, wherein the database enters, updates, and maintains electronic mail addresses for forwarding.

21. The method of claim 17, wherein a confirmation electronic mail with a password is sent to the user after user the registration.

22. The method of claim 17, wherein the user's electronic mail account is disabled after user registration.

23. The method of claim 19, wherein the user responds to one of the sender directly and to the sender indirectly through the server.

24. The method of claim 17, wherein the user's new electronic mail address may be made unavailable to the sender.

25. The method of claim 17, wherein the sender receives an electronic mail message from the user that informs the sender that the sender's electronic mail message was forwarded.

26. The method of claim 19, wherein the sender receives an electronic mail message from a server that informs the sender that the sender's electronic mail message was forwarded to the user.
